(19) United States
(12) Patent Application Publication
(10) Pub. No.: US 2019/0340347 A1
(43) Pub. Date: Nov. 7, 2019

(54) AUTHENTICATING TO WORKPLACE SYSTEMS VIA WEARABLE DEVICE

(71) Applicant: Microsoft Technology Licensing, LLC, Redmond, WA (US)

(72) Inventors: Donna Katherine LONG, Redmond, WA (US); Kenneth Liam KIEMELE, Redmond, WA (US); John Benjamin HESKETH, Kirkland, WA (US); Bryant Daniel HAWTHORNE, Duvall, WA (US); Jamie R. CABACCANG, Bellevue, WA (US); Kendall Clark YORK, Bellevue, WA (US); Jennifer Jean CHOI, Seattle, WA (US); Nir FINKELSTEIN, Redmond, WA (US)

(73) Assignee: Microsoft Technology Licensing, LLC, Redmond, WA (US)

(21) Appl. No.: 16/019,239

(22) Filed: Jun. 26, 2018

Related U.S. Application Data
(60) Provisional application No. 62/667,325, filed on May 4, 2018.

(51) Int. Cl. G06F 21/35; G06F 21/32; G06Q 20/40; G06K 19/14; G06K 19/07

(52) U.S. Cl. CPC G06F 21/35; G06F 21/32; H04W 12/06; G06K 19/145; G06K 19/0723; G06Q 20/40145

(57) ABSTRACT

Examples are disclosed that relate to a wearable device configured to authenticate a user, associate itself with the user, and then authenticate the user to one or more other systems. One example provides a wearable device including a communication subsystem, a logic subsystem, and a storage subsystem including instructions executable to receive an input of information identifying a user, based upon the input, authenticate the user as a known user within a physical environment associated with the wearable device, associate the user with the wearable device, conduct an authentication communication with another computing device within the physical environment via the communication subsystem to authenticate the user to the other computing device via the wearable device, dissociate the wearable device from the user upon occurrence of an end-of-use session event, and later authenticate a different user and associate the different user with the wearable device.

### CROSS REFERENCE TO RELATED APPLICATIONS

This application claims priority to U.S. Provisional Patent Application Ser. No. 62/667,325, filed May 4, 2018, the entirety of which is hereby incorporated herein by reference for all purposes.

### BACKGROUND

A workplace or jobsite may use systems to track employee sales, scheduling, timecards, and/or workflow processes. The accuracy of data gathered by such systems may rely upon user input throughout a shift, which may be inefficient and prone to error.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to a wearable device configured to authenticate a user, associate itself with the user, and then authenticate the user to one or more other systems. One example provides a wearable device including a communication subsystem, a logic subsystem, and a storage subsystem including instructions executable to receive an input of information identifying a user, based upon the input, authenticate the user as a known user within a physical environment associated with the wearable device, associate the user with the wearable device, conduct an authentication communication with another computing device within the physical environment via the communication subsystem to authenticate the user to the other computing device via the wearable device, dissociate the wearable device from the user upon occurrence of an end-of-use session event, and later authenticate a different user and associate the different user with the wearable device.

### BRIEF DESCRIPTION OF THE DRAWINGS

FIG. 1 depicts an example wearable device for authenticating a user to other devices.

FIGS. 2A-2B show an example wearable device in the form of an electronically functional nametag.

FIGS. 3A-3B show an example wearable device in the form of an electronically functional receptacle for a user identification badge.

FIG. 4 is a block diagram illustrating an example user authentication system.

FIG. 5 is a flowchart illustrating an example method for implementing a user authentication system.

FIG. 6 is a flowchart illustrating an example method for authenticating multiple users to different wearable devices.

FIG. 7 is a block diagram illustrating an example computing system.

### DETAILED DESCRIPTION

Employers may utilize various systems to gather employee work data. For example, workers may manually clock into and out of a timecard system to record start, end, and break times throughout a work day. However, a worker may fail to accurately report some data, such by recording a break time that is shorter than required under local, state, and/or federal regulations, or failing to record time worked outside of scheduled hours. As a result, the worker may receive improper compensation or may spend extra time requesting a timecard adjustment.

As another example, a worker may interact with a point-of-sale (POS) system (e.g., a cash register) that uses a manual user authentication, such as a username and password or other suitable credential set, to verify that an approved worker is handling monetary transactions. Such manual user authentication systems may be awkward and time-consuming and may detract from an interaction between the worker and a customer.

As another example, a workplace policy may describe specific procedures to be followed based upon staffing levels in a workplace. For example, workers' roles and duties may change when another worker leaves for a break or a worker is unexpectedly absent for a shift. While some workers may understand how to act upon such occurrences, others (e.g. new employees) may be uncertain. Further, even experienced employees may forget to adjust workflow upon such occurrences.

Accordingly, examples are disclosed that may address these problems and others in workplace environments. Briefly, the disclosed examples provide a wearable device configured to be inconspicuous to other persons when worn by a worker while working. The wearable device is configured to authenticate a user and then be associated with that user while the user wears the device. The device further may communicate with other systems in the environment, such as timekeeping systems and point-of-sale systems, to automatically authenticate the user to such systems while associated with the user, thereby proving seamless authentication to potentially a suite of devices that the user interacts with regularly and normally as part of their job. Further, the wearable device is reusable and sharable among employees, and thus may be used by different workers on different days/shifts, which may help to reduce implementation costs.

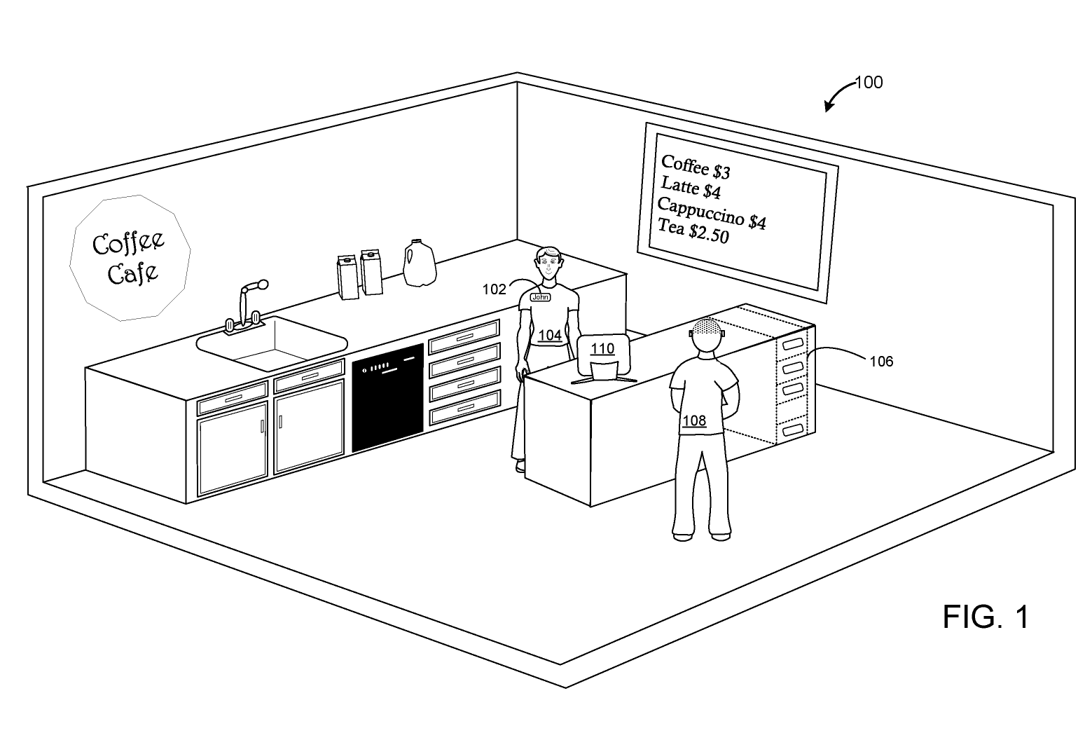

Prior to discussing these examples, FIG. 1 depicts an example use scenario 100 for a wearable device 102. User 104 is an employee of a coffee café. Upon arriving for a scheduled shift, the user 104 picks out any reusable wearable device 102 that is sufficiently charged from a charging/docking station 106. The user 104 then authenticates himself to the wearable device 102, which associates the wearable device 102 with the user 104 until the wearable device detects an end-of-use session event, such as returning the wearable device 102 to the charging/docking station 106. The association to and dissociation from the wearable device may be recorded as clock in/clock out events in a workplace timekeeping system (e.g., by sending a message including time information to a computing system that stores timekeeping records), which may help to reduce inefficiencies associated with manually clocking into and out of the timekeeping system. Further, as mentioned above, once the wearable device 102 is removed from the user 104 and/or returned to the charging/docking station 106, another user may authenticate themselves to the wearable device 102 to seamlessly authenticate to various devices to which the other user is permitted access.

Continuing with FIG. 1, the user 104 is taking an order for a customer 108. While wearing the wearable device 102, the user 104 is automatically authenticated to the point-of-sale system, for example, via a Bluetooth or other communication mechanism between the point-of-sale system 110 and the wearable device 102. Such automatic authentication may be faster and easier for the user 104 to perform than a manual username/password entry or other manual authentication process, and thus may allow the user 104 to engage with the customer 108 more quickly. Further, at a later time when the user 104 is relieved of his point-of-sale role by a colleague in the coffee café, the wearable device 102 may automatically end a user session of user 104 with the point-of-sale system 110 and authenticate the colleague to the point-of-sale system based upon authentication provided by the colleague's wearable device. Similarly, if the user 104 steps away from the point-of-sale system 110 briefly, the wearable device 102 may disassociate the user 104 with the point-of-sale system while the user is away. In this manner, if a colleague briefly operates the point-of-sale system 110 while the user 104 is away, the colleague's wearable device may be associated with the point-of-sale system 110 during that time. This may help to more accurately track sales and performance metrics for different workers. Further, automatically disassociating the user 104 with the point-of-sale system 110 while the user is away may help prevent unauthorized users from accessing the point-of-sale system.

The wearable device may also be used to record notes and reminders for users in a convenient manner. For example, the wearable device may include a microphone for receiving voice input, and the user authenticated to the wearable device may use the microphone to record voice notes, reminders and/or instructions to be replayed at a later time to themselves and/or another user. In some examples, the microphone may be directional to reduce signal noise arising from sounds received from directions other than user's mouth. Further, in some examples, a wearable device may include a second microphone directed away from a user's mouth to receive ambient noise for ambient noise-cancellation to improve a signal/noise ratio of the signal from the user-facing microphone.

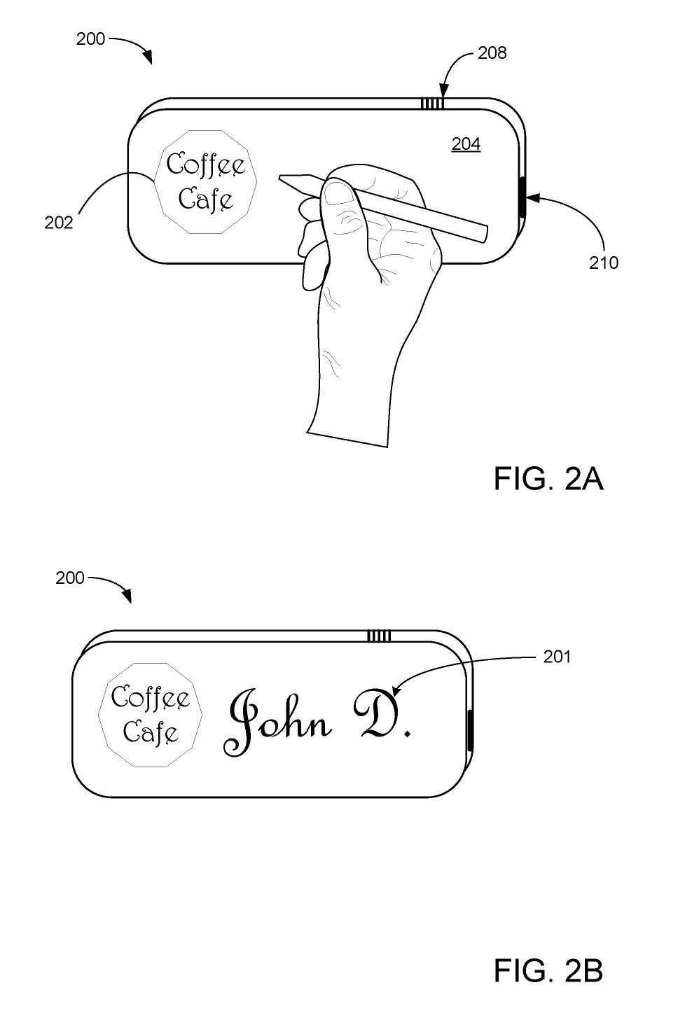

FIGS. 2A and 2B show an example electronically functional nametag 200 suitable for use as wearable device 102 of FIG. 1. First referring to FIG. 2A, the nametag 200 may have a space 204, shown here next to a company logo 202, on which a current user may write or otherwise place their name when starting a use session with the nametag. Because a wearable device as disclosed herein is not permanently designated to a specific user, implementation costs may be reduced by purchasing a sufficient quantity of the wearable devices for a shift or fully staffed workday, but not one for every employee (as different employees may work different shifts/days).

At the start of a use session, the employee may authenticate to the nametag 200 to cause the nametag to be associated with the user for the use session. Any suitable authentication method may be used. In some examples, one or more biometric inputs, such as voice, fingerprint, eye scan, and/or facial recognition, may be used to authenticate the user to the nametag (e.g., by comparing the biometric input to stored biometric data for known users). Suitable sensors, such as a microphone, a camera, and/or a capacitive fingerprint sensor, for receiving a biometric authentication input, may reside on the nametag 200 or may reside on another device, such as a hub or charging/docking station for the nametag 200, or a computing device in communication with such a charging/docking station. As another example, an authenticating input may take the form of a near-field communication (NFC) or radiofrequency identification (RFID) communication exchange with a known device associated with the user (e.g., a smartphone or employee badge of the user). As a further example, the nametag 200 may be configured to identify a user from handwriting of the user. In such an example, a sensor (e.g. a capacitive sensing array configured to detect a stylus touch) may be used to track the handwriting input and authenticate the user by the handwriting. Such sensing may be performed as the user writes their name on the nametag at the start of a shift, for example, by employing a suitable touch sensor beneath the space 204 in which the user writes their name. In yet other examples, the nametag 200 may identify a current user via an observed pattern of usage, such as comparing a time and location of the current user to shift and role records for employees. In yet other examples, the authentication input may be provided to another computing device. In such examples, the other computing device may associate a nametag with the user after authentication is confirmed. As a more specific example, a charging/docking station for the nametag 200 may include a display and keyboard (or other input device), and a user may input login credentials (e.g., a username and passcode) to the charging/docking station at the beginning of a shift to authenticate to a nametag.

Nametag 200 further may comprise one or more output devices configured to provide outputs to a user. In the example of FIGS. 2A and 2B, the nametag 200 includes a speaker 208 configured to provide audio output to the user. The speaker may be configured to direct audio output upwards towards the user in a directional manner, thereby allowing the wearer to hear the output while reducing a perceptibility of the audio output by other persons. A wearable device also may include other output devices, such as one or more haptic devices, displays, and/or light sources.

Nametag 200 further may comprise a charging port 210 configured to connect the nametag 200 to a suitable power source. Any suitable charging mechanism may be used. In some examples, the nametag 102 includes a universal serial bus (USB) port configured to connect the nametag to a peripheral device, such as the charging/docking station 106, via a USB cable. In other examples, the nametag 102 may omit a charging port and may instead be configured to charge wirelessly via inductive charging.

As described above, the nametag 200 is communicatively coupled to a computing system (e.g., a local server and/or a cloud-based computing system) that stores employee records, such as timekeeping records and other data that is tracked for employees. Once a user is authenticated to the nametag 200, the nametag 200 may transmit information obtained from one or more sensors on the nametag 200 to the computing system. The computing system may determine notifications to send the nametag 200 based upon the information received from the nametag 200 and/or other suitable data regarding the user and the workplace (e.g., the user's schedule, the user's role in the use environment, and/or workplace policies regarding workflow and staffing). The computing system(s) may further receive data from one or more communicatively coupled devices within the use environment (e.g., IoT devices such as appliances, machinery, point-of-sale system, etc.), and send notifications to the nametag 200 regarding any devices being (or predicted to be) in an actionable state (e.g. that coffee being ground by an IoT-configured coffee grinder is complete).

As other examples of notifications that may be presented via nametag 200, notifications regarding timekeeping and scheduling may be provided to help comply with workplace regulatory requirements, such as mandatory break and lunch regulations. For example, the nametag 200 may include a haptic device that is triggered to vibrate upon receiving a notification regarding a start time of a mandated break, and to vibrate again upon receiving a notification of the end time of the mandated break. Audio and/or visual outputs similarly may be used.

In some examples, the nametag 200 may be configured to provide other types of notifications. For example, as described above, a workplace may have specified workflows that are to be followed based upon staffing levels. Thus, the nametag 200 may output notifications to users to change roles when staffing levels change. In such an example, a computing system to which the nametag 200 is communicatively coupled may receive data from each present staff member's nametag regarding a current workstation of the staff member (e.g. point-of-sale, stock room). For example, where an employee is authenticated with a POS system, the computing system receiving employee data may receive information on this state. Likewise, where an employee is on break, one or more sensors in the break room (e.g. an RFID sensor at the break room entrance) may detect when employees enter or leave the breakroom. The computing system may use such information, together with information regarding which employees have authenticated to nametags that day, to notify current employees who are not on break how to modify workflow, e.g. by sending notification messages to the nametags for output by the nametags, or by triggering the output of preconfigured notification messages stored on the nametags. In this manner, the nametag 102 may be used to help increase compliance with rules and procedures of a workplace. Similarly, a wearable device may be used to output notifications comprising instructions to help train a new employee, provide real-time feedback regarding employee performance, and/or provide any other suitable notifications.

In some examples, the nametag 200 may also track a spatial location of the user in a use environment. A user's spatial location may be used, in some examples, to determine whether a user is taking required breaks in compliance with local, state, and/or federal regulations. In other examples, a user's spatial location may be used to ensure the user is properly compensated for working during a portion of a specified break time, working a longer shift than scheduled, and/or for working overtime. Further, in yet other examples, the user's spatial location may be used to automatically time breaks and rearrange duties among other users, as described above.

A wearable device may track spatial location in any suitable manner. Example methods include ultrasonic transmission (e.g., chirp), proximity-dependent wireless communication with other object(s) in the use environment (e.g. Bluetooth communications), triangulation via Wi-Fi hotspots, feature recognition using image data from an integrated camera that images known markers in the environment, and/or one or more camera(s) external to the nametag.

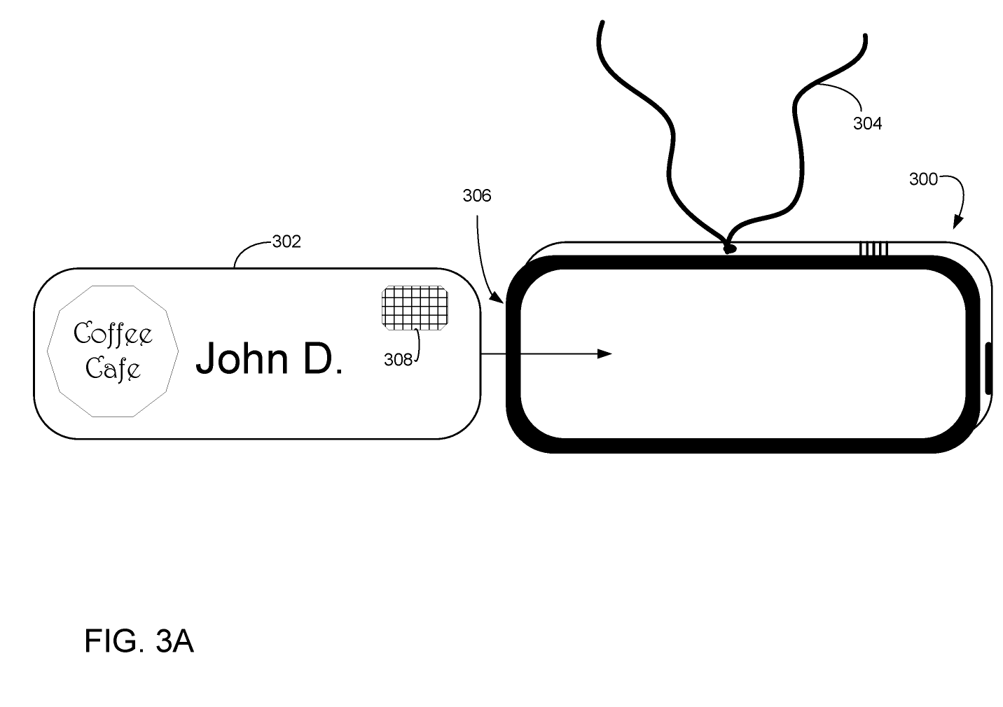

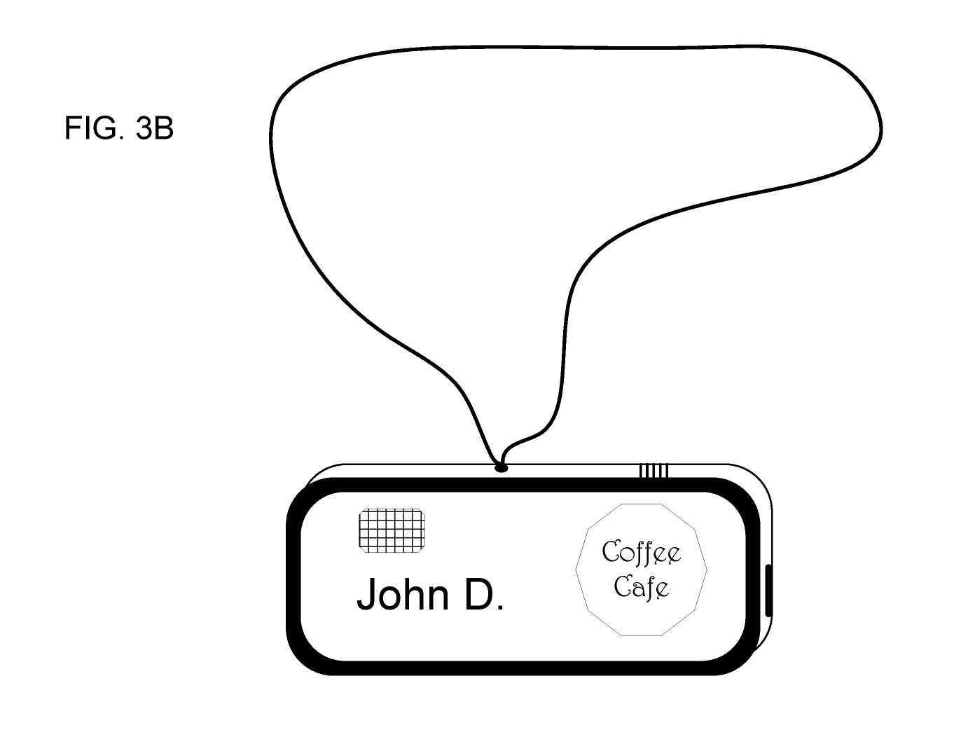

FIG. 3A depicts another example wearable device in the form of a receptacle 300 suitable for use as wearable device 102 of FIG. 1. Receptacle 300 is configured to receive a user identification badge 302. In this example, the receptacle 300 includes a necklace attachment 304 configured to be worn around a neck of a user to form an employee nametag from the combination of the badge and the receptacle. In other examples, a wearable device may take any other suitable form, such as a pin, a button, and/or another item of jewelry. It will be understood that the receptacle 300 may comprise any suitable hardware, including the examples described with reference to FIGS. 1, 2, 4, and 5.

Similar to the above-described nametag, the receptacle 300 is in a user-unassociated state until the user identification badge 302 is inserted into an opening 306 of the receptacle, which authenticates the user to the receptacle and associates the user with the receptacle as shown in FIG. 3B. The receptacle may authenticate the user to the receptacle in any suitable manner. In the example of FIGS. 3A and 3B, the identification badge 302 is encoded with a machine-readable user identifier (e.g., an optically readable code, RFID tag, and/or other machine-readable identifier) detectable by a code reader of the receptacle 300. In this manner, the receptacle 300 may be integrated with an existing identification badge system to increase functionality of the identification badges. Further, as described above, implementation costs may be reduced by purchasing a sufficient quantity of the receptacles for a shift or fully staffed workday, but fewer than one for every employee (as different employees may work different shifts/days).

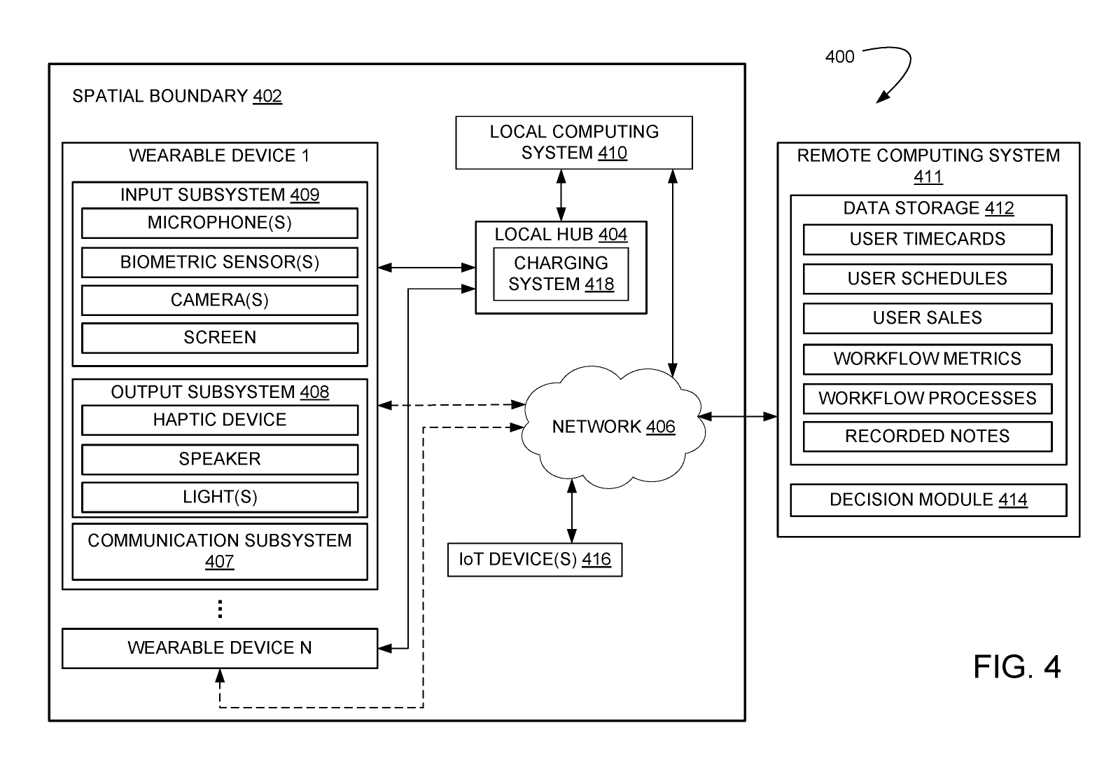

FIG. 4 depicts an example system 400 for implementing one or more wearable devices. The system 400 is configured to operate within a spatial boundary 402 defining a physical environment. The term “spatial boundary” refers to a place of work, such as a jobsite, a physical store location, a warehouse, an office, etc., and in some cases may not correspond to an actual physical boundary, but rather to a communication range of devices operating in the workspace. Within the spatial boundary 402, one or more wearable devices (shown as device 1 through device N) communicate, via a communication subsystem 407 of each wearable device, with a computing system, for example, over a wireless local- or wide-area network 406. Such communication may be directly with the computing system via a network 406 (as shown in dashed lines), or via a local communication hub 404 (e.g. a charging station/hub for the wearable devices), as shown in solid lines. Example communication protocols include Bluetooth, Wi-Fi, RFID, and ultrasonic transmission.

Wearable devices 1 through N each comprises an output subsystem 408 including one or more output devices. The wearable devices each may include any suitable output device, such as one or more haptic device(s), speaker(s), display(s), and light(s). In some examples, the wearable devices 1 through N each include a directional speaker (e.g. a speaker enclosed in a cone- or pipe-shaped enclosure) to help reduce a likelihood nearby persons will hear messages intended for the wearer.

The wearable devices 1 through N each further may comprise an input subsystem 409 including one or more input devices. For example, the wearable devices 1 through N each may comprise a microphone configured to receive user voice input. The input subsystem 409 further may additionally or alternatively include a fingerprint sensor, a capacitive touch sensor, a thermal sensor, and/or a camera. In other examples, the wearable devices 1 through N each may include any other suitable input device(s).

Each wearable device 1 through N may include other components not shown in this figure. For example, each wearable device comprises a power supply, such as one or more batteries. In some examples, the wearable devices 1 through N use low-power computing processes to preserve battery power during use. Further, the battery of each wearable device may be rechargeable (e.g., via charging/docking station 106) between uses.

As mentioned above, each wearable device may communicate with a computing system that maintains employee records. Such a computing system may be local to the physical environment, and/or located remotely (e.g. hosted in a cloud-based computing system). As such, FIG. 4 illustrates a computing system 410 and a remote computing system 411. As illustrated at 411, the computing system(s) 410, 411 comprise data storage 412 storing various user data, which may include user timecards, user schedules, user sales data, workflow metrics, workflow processes, and/or notes recorded by a wearable device(s), as examples. The computing system(s) 410, 411 further comprise a decision module 414 that determines a course of action based upon data stored in data storage 412 and a current state of one or more wearable devices 1 through N. The decision module may transmit the course of action as a notification for output by one or more wearable devices 1 through N, in some examples.

The system 400 further comprises one or more Internet of Things (IoT) devices 416 within the spatial boundary 402 that communicate with the computing system(s) 410, 411. Example devices 416 include a point-of-sale system, appliances, machinery, and locks to access-restricted locations. The computing system 410, 411 may detect or predict an actionable state of an IoT device 416, and in response may transmit a notification for output by one or more wearable devices 1 through N based upon factors such as the actionable state and/or a spatial location of the one or more wearable devices 1 through N relative to the IoT device. Further, a wearable device authenticated to a user may seamlessly permit the user authentication to one or more of the IoT devices 416 to which the user is permitted access.

The system 400 further comprises a charging system 418 (e.g., charging/docking station 106) for charging the wearable devices 1 through N between uses. The charging system 418 may be configured to wirelessly charge a battery of each wearable device, for example, via inductive charging or may be configured to charge a battery of each wearable device via a wired connection. In FIG. 4, the charging system 418 is shown as being integrated with the hub 404, but also may be a separate device in some examples.

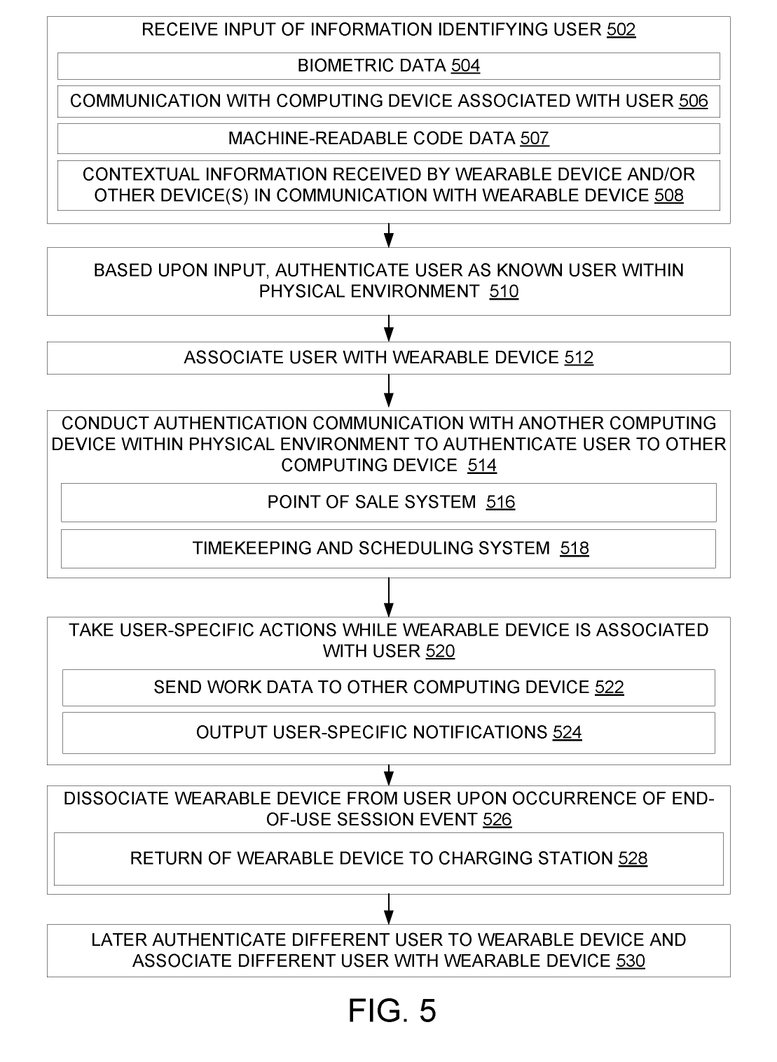

FIG. 5 shows a flowchart illustrating an example method 500 for implementing a user authentication system. Method 500 may be implemented as stored instructions executable on a computing device, such as a wearable device as disclosed herein.

At 502, method 500 comprises receiving an input of information identifying a user. Any suitable input may be received. Examples include, but are not limited to, biometric inputs 504 (e.g. a voice signal received from a local microphone, a fingerprint scan as received from a capacitive or other fingerprint sensor, image data capturing biometric information (e.g. an eye scan or facial scan) as received from an image sensor, and/or a handwriting input as received from a touch sensor), communication from other computing devices associated with user 506 (e.g. a near-field communication or RFID communication with another device, such as a smartphone), and/or machine-readable code data 507 (e.g. as read by a wearable device that accepts insertion of a user identification badge). Further, the input of information may comprise contextual information received by the wearable device and/or devices in communication with the wearable device that allows the user to be identified by an observed pattern of usage, as indicated at 508.

At 510, method 500 comprises, based upon the input, authenticating the user as a known user within a physical environment associated with the wearable device. In some examples, the user input received at 502 may be compared to locally stored authentication information. In such examples, identifying information for each employee who is authorized to use the wearable device may be stored on each available wearable device for local authentication. In other examples, the information received at 502 may be sent to an external device (e.g. computing system(s) 410, 411, hub 404, and/or other suitable computing systems) in raw or processed form, and a confirmation of the authentication may be received from the external device. As mentioned above, the information used to authenticate the user may take any suitable form, such as a voice input, a fingerprint input, an image input, a handwriting input, an observed pattern of usage, near-field communication between the wearable device and a device associated with the user, etc.

Based on the authentication, method 500 comprises, at 512, associating the user with the wearable device. Associating the user with the wearable device may include storing the association locally on the wearable device, and/or at an external computing device. Once associated with the user, the wearable device may be used to seamlessly authenticate the user to other device(s) to which the user is permitted access while the wearable device is associated with the user. Thus, at 514, method 500 comprises conducting an authentication communication with another computing device within the physical environment to authenticate the user to the other computing device via the wearable device. Where the association of the user with the wearable device is stored locally on the wearable device, such authentication may be performed by direct communication between the wearable device and the other computing device. In other examples, the authentication process may utilize one or more additional computing devices (e.g., computing systems 410, 411, local hub 404, etc.) to assist with the authentication. The wearable device may authenticate the wearer to any suitable other device in the environment. For example, in a retail environment, the user may be authenticated to a point-of-sale system 516 when the user is standing at the point-of-sale system and thereby associate the user as currently operating the point-of-sale system. As another example, the user may be authenticated to a timekeeping and scheduling system 518. A user also may be authenticated to other computers in the environment, machinery, appliances, locks to access restricted locations, etc.

After association with the user, user-specific actions may be taken while the nametag is associated with the user, as indicated at 520. For example, data related to the user's work may be sent to another device for storage, as indicated at 522. This may allow tracking of user performance data. Examples include tracking hours worked, breaks, compliance with workplace policies, and/or user performance. Further, user-specific notifications may be output by the wearable device, as indicated at 524. Such notifications may be stored locally on the wearable device and/or received from an external computing device (e.g., computing system 410, 411, local hub 404, etc.). Any suitable notifications may be output. Examples may include notifications regarding time and/or schedule (e.g. a reminder to take a break), notifications regarding states of devices in the environment (e.g. a notification that a machine has finished a food preparation process), and notifications regarding roles to perform (e.g. a notification to change workstations based on a change in staffing).

Continuing, at 526, method 500 comprises dissociating the wearable device from the user upon occurrence of an end-of-use session event, such as detecting a return of the wearable device to a charging station 528, and at 530, later authenticating a different user to the wearable device and associating the different user with the wearable device. In this matter, a wearable device may be shared among users, which may help to reduce implementation costs. This may allow a business or other entity to purchase sufficient wearable devices for all staff during a shift or workday, but fewer wearable device than a total number of employees, due to the ability to associate a wearable device with different staff at different times.

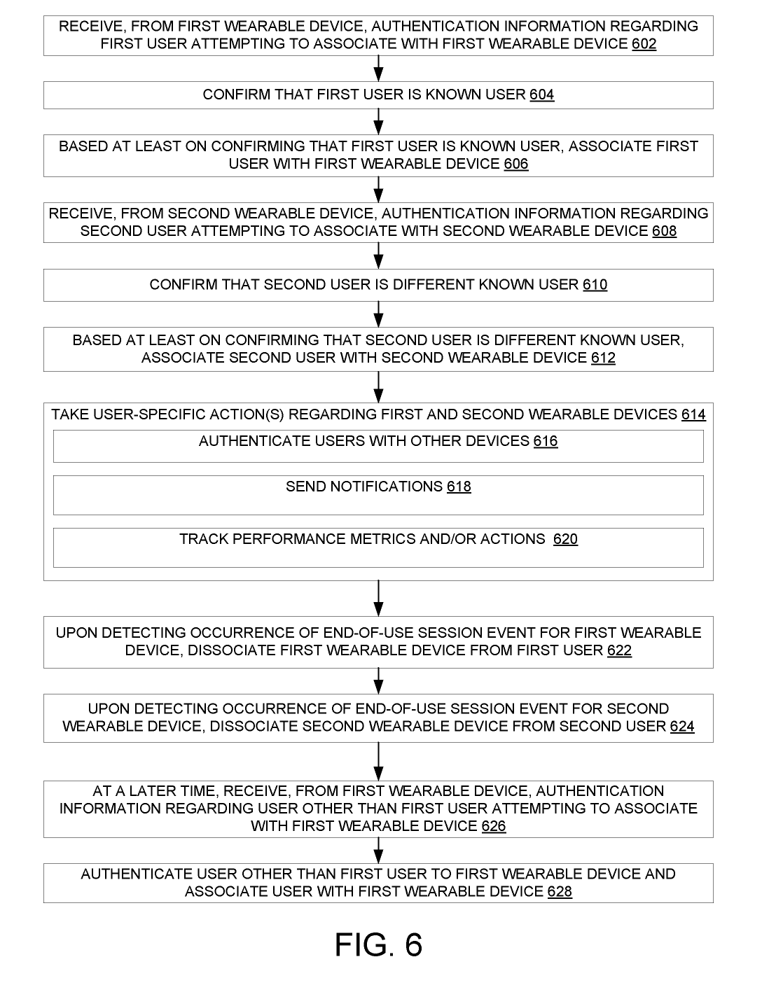

FIG. 6 is a flowchart illustrating an example method 600 for authenticating plural users to wearable devices during a shift and later associating a wearable device with a different user. Method 600 may be implemented as stored instructions executable by a computing system, such as computing systems 410, 411 and/or local hub 404. At 602, method 600 comprises receiving, from a first wearable device, authentication information regarding a first user attempting to associate with a first wearable device, and at 604, confirming that the first user is a known user. The authentication information may be received from the wearable device, via user input to the computing device executing method 600, or from a different device (e.g. another computing device used by employees to clock in at the beginning of a user session). Likewise, confirming that the first user is a known user may be performed locally, remotely at the wearable device (in which case the confirmation is received from the wearable device), or via any other suitable computing device.

At 608, method 600 comprises receiving, from a second wearable device, authentication information regarding a second user different from the first user attempting to associate with the second wearable device. At 610, method 600 comprises confirming that the second user is a known user, and at 612, associating the second user with the second wearable device.

Once both users are authenticated to different wearable devices, method 600 comprises, at 614, taking user-specific actions with regard to the first and second wearable devices. For example, as indicated at 616, method 600 may comprise assisting in authenticating users of the first and second wearable devices to other devices in the location (e.g. a point-of-sale system, employee record keeping system, various machines and other devices) via communications with the wearable devices and with the other devices to which the users are being authenticated. As another example, user-specific notifications may be sent at 618 to the first and second wearable devices for output to the users associated with those devices. Example of such notifications include notifications regarding time and/or schedule (e.g. a reminder to take a break), notifications regarding states of devices in the environment (e.g. a notification that a machine has finished a food preparation process), and notifications regarding roles to perform (e.g. a notification to change workstations based on a change in staffing). As a further example, user specific performance metrics for the first user and the second user may be tracked while each user is authenticated to the wearable device, as indicated at 620. For example, sales attributed to each user may be tracked while the users are authenticated to a point of sale system.

At 622, method 600 comprises, upon detecting occurrence of an end-of-use session event for the first wearable device, dissociating the first wearable device from the first user. Further, at 624, method 600 comprises, upon detecting an occurrence of an end-of-use session event for the second wearable device, dissociating the second wearable device from the second user. Any suitable events may end a use session, including but not limited to the wearable device being returned to a charging station, or detecting that the wearable device has been removed from a user's clothing and/or body. In some instances, an end-of-use session event may be confirmed by comparing a timing of the end-of-use session event to a user's schedule. Further, the dissociation from the wearable device may be used to clock out a user, e.g. by recording the dissociation in timekeeping records for the user.

At 626, method 600 comprises, at a later time, receiving, from the first wearable device, authentication information regarding a user other than the first user attempting to associate with the first wearable device. For example, a user working a different shift or on a different day than the first user may attempt to authenticate to with the first wearable device. At 628, method 600 comprises authenticating the user other than the first user to the first wearable device and associating the user with the first wearable device. In this manner, a wearable device may be shared among users and authenticated to any user authorized to use the wearable device, which may help to reduce implementation costs.

In some embodiments, the methods and processes described herein may be tied to a computing system of one or more computing devices. In particular, such methods and processes may be implemented as a computer-application program or service, an application-programming interface (API), a library, and/or other computer-program product.

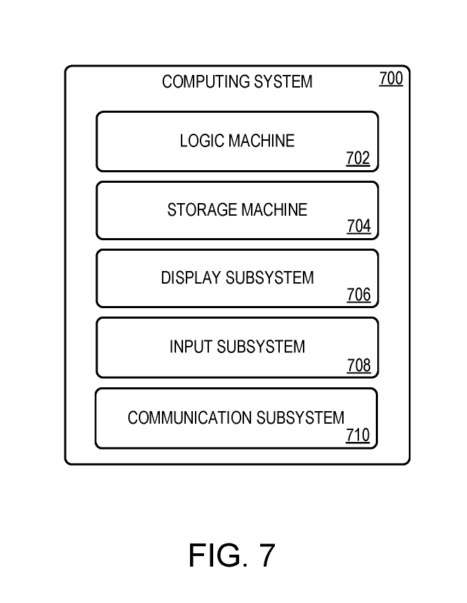

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices. Computing system 700 may be an example of any of the computing systems, IoT devices, and even some implementations of the wearable devices described herein.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine 702 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 702 may include one or more processors configured to execute software instructions. Additionally or alternatively, the logic machine 702 may include one or more hardware or firmware logic machines configured to execute hardware or firmware instructions. Processors of the logic machine 702 may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine 702 may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module” and “program” may be used to describe an aspect of computing system 700 implemented to perform a particular function. In some cases, a module or program may be instantiated via logic machine 702 executing instructions held by storage machine 704. It will be understood that different modules and/or programs may be instantiated from the same application, service, code block, object, library, routine, API, function, etc. Likewise, the same module and/or program may be instantiated by different applications, services, code blocks, objects, routines, APIs, functions, etc. The terms “module” and “program” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 700 may include wired and/or wireless communication devices compatible with one or more different communication protocols. As non-limiting examples, the communication subsystem 710 may be configured for communication via a wireless telephone network, a wired or wireless local- or wide-area network, or acoustically via an ultrasonic transmitter/receiver. In some embodiments, the communication subsystem may allow computing system 700 to send and/or receive messages to and/or from other devices via a network such as the Internet.

Another example provides a wearable device, comprising a communication subsystem, a logic subsystem, and a storage sub system comprising instructions executable to receive an input of information identifying a user, based upon the input, authenticate the user as a known user within a physical environment associated with the wearable device, associate the user with the wearable device, conduct an authentication communication with another computing device within the physical environment via the communication subsystem to authenticate the user to the other computing device via the wearable device, dissociate the wearable device from the user upon occurrence of an end-of-use session event, and later authenticate a different user and associate the different user with the wearable device. In such an example, the wearable device may additionally or alternatively comprise an output subsystem comprising one or more of a speaker, a display, a light, and a haptic device. In such an example, the speaker may additionally or alternatively comprise a directional speaker. In such an example, the instructions may additionally or alternatively be executable to detect the occurrence of the end-of-use session event by detecting a return of the wearable device to a charging station. In such an example, the wearable device may additionally or alternatively comprise a receptacle for a machine-readable user identifier. In such an example, the receptacle may additionally or alternatively comprise a code reader configured to read a code encoded into the machine-readable user identifier. In such an example, the code may additionally or alternatively comprise one or more of an optically readable code and an RFID tag. In such an example, the wearable device may additionally or alternatively comprise an input subsystem comprising one or more of a microphone, an image sensor, a fingerprint sensor, and a thermal sensor. In such an example, the instructions may additionally or alternatively executable to authenticate the user as the known user based upon one or more of a voice input, a fingerprint, facial recognition, and an eye scan. In such an example, the instructions may additionally or alternatively be executable to authenticate the user based upon a handwriting input. In such an example, the instructions may additionally or alternatively be executable to authenticate the user as the known user based upon an observed pattern of usage. In such an example, the instructions may additionally or alternatively be executable to authenticate the user as the known user based upon near-field communication between the wearable device and a device associated with the user.

Another example provides a system, comprising a logic subsystem, and memory holding instructions executable by the logic subsystem to receive, from a first wearable device, authentication information regarding a first user attempting to associate with the first wearable device, confirm that the first user is a known user, based at least on confirming that the first user is the known user, associate the first user with the first wearable device, receive, from a second wearable device, authentication information regarding a second user attempting to associate with the second wearable device, confirm that the second user is a different known user, based at least on confirming that the second user is the different known user, associate the second user with the second wearable device, upon detecting occurrence of an end-of-use session event for the first wearable device, disassociate the first wearable device from the first user, upon detecting occurrence of an end-of-use session event for the second wearable device, disassociate the second wearable device from the second user, at a later time, receive, from the first wearable device, authentication information regarding a user other than the first user attempting to associate with the first wearable device, and authenticate the user other than the first user to the first wearable device and associate the user with the first wearable device. In such an example, the instructions may additionally or alternatively be executable to send to the first wearable device a notification regarding an actionable state of another device for output by the wearable device. In such an example, the instructions may additionally or alternatively be executable to send to the first wearable device a notification regarding a schedule of the first user for output by the first wearable device. In such an example, the instructions may additionally or alternatively be executable to receive information regarding actions of the first user while the first wearable device is authenticated to the communicatively coupled device, and store the information regarding the actions of the first user. In such an example, the instructions may additionally or alternatively be executable to confirm that the first user is a known user by comparing the authentication information regarding the first user attempting to associate with the first wearable device to one or more of a schedule and biometric data for the first user.

Another example provides a machine-implemented method performed by a wearable device, the method comprising receiving an input of information to the wearable device, the information identifying a user attempting to associate with the wearable device, based upon the input, authenticating the user as a known user within a physical environment associated with the wearable device, associating the user with the wearable device, conducting an authentication communication with another computing device within the physical environment of the wearable device to authenticate the user to the other computing device via the wearable device, dissociating the wearable device from the user upon occurrence of an end-of-use session event, and at a later time, authenticating a different user to the wearable device and associate the different user with the wearable device. In such an example, the method may additionally or alternatively comprise outputting a notification via the wearable device based on one or more of a schedule of the user, an actionable state of a device, and a role of the user within the physical environment. In such an example, conducting the authentication communication with the other computing device may additionally or alternatively comprise conducting the authentication communication with a point-of-sale system to authenticate the user to the point-of-sale system.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A wearable device, comprising:
a communication subsystem;
a logic subsystem; and
a storage subsystem comprising instructions executable to
receive an input of information identifying a user,
based upon the input, authenticate the user as a known user within a physical environment associated with the wearable device,
associate the user with the wearable device,
conduct an authentication communication with another computing device within the physical environment via the communication subsystem to authenticate the user to the other computing device via the wearable device,
dissociate the wearable device from the user upon occurrence of an end-of-use session event, and
later authenticate a different user and associate the different user with the wearable device.

2. The wearable device of claim 1, further comprising an output subsystem comprising one or more of a speaker, a display, a light, and a haptic device.

3. The wearable device of claim 2, wherein the speaker comprises a directional speaker.

4. The wearable device of claim 1, wherein the instructions are executable to detect the occurrence of the end-of-use session event by detecting a return of the wearable device to a charging station.

5. The wearable device of claim 1, wherein the wearable device comprises a receptacle for a machine-readable user identifier.

6. The wearable device of claim 5, wherein the receptacle comprises a code reader configured to read a code encoded into the machine-readable user identifier.

7. The wearable device of claim 6, wherein the code comprises one or more of an optically readable code and an RFID tag.

8. The wearable device of claim 1, further comprising an input subsystem comprising one or more of a microphone, an image sensor, a fingerprint sensor, and a thermal sensor.

9. The wearable device of claim 8, wherein the instructions are executable to authenticate the user as the known user based upon one or more of a voice input, a fingerprint, facial recognition, and an eye scan.

10. The wearable device of claim 1, wherein the instructions are executable to authenticate the user based upon a handwriting input.

11. The wearable device of claim 1, wherein the instructions are executable to authenticate the user as the known user based upon an observed pattern of usage.

12. The wearable device of claim 1, wherein the instructions are executable to authenticate the user as the known user based upon near-field communication between the wearable device and a device associated with the user.

13. A system, comprising:
a logic subsystem; and
memory holding instructions executable by the logic subsystem to
receive, from a first wearable device, authentication information regarding a first user attempting to associate with the first wearable device;
confirm that the first user is a known user;
based at least on confirming that the first user is the known user, associate the first user with the first wearable device;
receive, from a second wearable device, authentication information regarding a second user attempting to associate with the second wearable device;
confirm that the second user is a different known user;
based at least on confirming that the second user is the different known user, associate the second user with the second wearable device;
upon detecting occurrence of an end-of-use session event for the first wearable device, disassociate the first wearable device from the first user;
upon detecting occurrence of an end-of-use session event for the second wearable device, disassociate the second wearable device from the second user;
at a later time, receive, from the first wearable device, authentication information regarding a user other than the first user attempting to associate with the first wearable device; and
authenticate the user other than the first user to the first wearable device and associate the user with the first wearable device.

14. The system of claim 13, wherein the instructions are further executable to send to the first wearable device a notification regarding an actionable state of another device for output by the wearable device.

15. The system of claim 13, wherein the instructions are further executable to send to the first wearable device a notification regarding a schedule of the first user for output by the first wearable device.

16. The system of claim 13, wherein the instructions are further executable to receive information regarding actions of the first user while the first wearable device is authenticated to the communicatively coupled device, and store the information regarding the actions of the first user.

17. The system of claim 13, wherein the instructions are executable to confirm that the first user is a known user by comparing the authentication information regarding the first user attempting to associate with the first wearable device to one or more of a schedule and biometric data for the first user.

18. A machine-implemented method performed by a wearable device, the method comprising:
receiving an input of information to the wearable device, the information identifying a user attempting to associate with the wearable device;
based upon the input, authenticating the user as a known user within a physical environment associated with the wearable device;
associating the user with the wearable device;
conducting an authentication communication with another computing device within the physical environment of the wearable device to authenticate the user to the other computing device via the wearable device;
dissociating the wearable device from the user upon occurrence of an end-of-use session event; and
at a later time, authenticating a different user to the wearable device and associate the different user with the wearable device.

19. The machine-implemented method of claim 18, further comprising outputting a notification via the wearable device based on one or more of a schedule of the user, an actionable state of a device, and a role of the user within the physical environment.

20. The machine-implemented method of claim 18, wherein conducting the authentication communication with the other computing device comprises conducting the authentication communication with a point-of-sale system to authenticate the user to the point-of-sale system.
